(19) United States
(12) Patent Application Publication
(10) Pub. No.: US 2010/0095228 A1
(43) Pub. Date: Apr. 15, 2010

(54) APPARATUS AND METHOD FOR PROVIDING USER INTERFACE BASED ON STRUCTURED RICH MEDIA DATA

(75) Inventors: Seo Young Hwang, Suwon-si (KR); Kyung Mo Park, Seoul (KR); Jae Yeon Song, Seoul (KR); Kook Heui Lee, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/576,758

(22) Filed: Oct. 9, 2009

(30) Foreign Application Priority Data
Oct. 10, 2008 (KR) 10-2008-0099720

(51) Int. Cl. G06F 3/048

(52) U.S. Cl. 715/762; 715/764

(57) ABSTRACT

An apparatus and method are provided for providing a structured rich media-based User Interface (UI) for producing situation-adaptive UI with a structured UI format composed of the rich media data including diverse multimedia and interactions. AUI UI format is created that includes a header and scene data. The header contains basic information on the UI and the scene data is composed of the UI. The UI format is encoded. The encoded UI format is transmitted. The header further includes initial information, configuration information, and layout information.

### PRIORITY

This application claims priority under 35 U.S.C. §119(a) to an application entitled “APPARATUS AND METHOD FOR PROVIDING UI BASED ON STRUCTURED RICH MEDIA DATA” filed in the Korean Intellectual Property Office on Oct. 10, 2008 and assigned Serial No. 10-2008-0099720, the content of which is incorporated herein by reference.

### BACKGROUND OF THE INVENTION

1. Field of the Invention

The present invention relates generally to a graphic User Interface (UI) and, more particularly, to an apparatus and method for providing a structured rich media-based UI that is capable of producing a situation-adaptive UI with a structured UI format composed of the rich media data, which includes diverse multimedia and interactions.

2. Description of the Related Art

A UI is a physical or virtual agency created for temporary or constant interaction between users and a system (a machine, computer program, etc.). A UI provides input means for the user to manipulate the system and output means for the system to indicate the effects of the user's manipulation. UIs are a vendor-specific proprietary technology. Thus, they typically only operate with the device produced by the vendor, and are not capable of being reproduced or modified without permission.

Due to the fact that a user's needs, and thus, corresponding service providers, have diversified, and different media (including video, voice, data, and so forth), services and networks have converged, a common user-friendly interface is required. The common interface would operate in heterogeneous and even remote devices beyond the traditional concept of a single UI to a single device. The term ‘user-friendly’ means that little training is required for users, even beginners, to handle the device and services with the UI.

Interaction between a user and a device has evolved from simply an action performed between the user and the device to intelligent behavior capable of recognizing the user's situation and providing services in accordance with information on what the user can do, wants to do, and has to do based on the user's situation. This new UI differs from the traditional user-centric interfaces that provide services in consideration of the capabilities of the user and device and make the user adapt to or learn the device and functions. Specifically, the new UI is intended to provide a more context-aware interactive interface.

Current technology trends have focused on developments of rich media services in which various media contents including text, audio, video, pictures, graphics are provided in an integrated format. Lightweight Application Scene Representation (LASeR), formally known as ISO/IEC 14496-20 (MPEG-4 20), and Binary Format for Scene (BIFS), known as ISO/IEC 14496-11 (MPEG-4 11), are representative rich media service standards.

A rich media service provides enriched content along with a free representation of various multimedia elements, and an interaction with the user using such data as scene descriptions, videos, audios, images, fonts, texts, metadata, and scripts.

FIG. 1 is a flowchart illustrating operations of a terminal receiving a conventional rich media service.

Referring to FIG. 1, the terminal receives the LASeR service in step 100 and decodes LASeR content of the LASeR service in step 110. The terminal checks the LASeR commands contained in the decoded LASeR content. The LASeR commands are executed by the terminal in step 120, and events are processed to provide the user with the LASeR content in a predetermined format. The terminal outputs the LASeR content through video and/or audio processing means, such as, for example, by rendering scenes, in step 130.

The LASeR content can be expressed as a syntax as provided in Table 1.

TABLE 1

<NewScene>
<svg>

...

</svg>
</NewScene>

Referring to Table 1, the terminal renders and displays scenes (<svg> . . . </svg>) included in a corresponding LASeR command every time the LASeR command (<NewScene>) is executed.

Since a conventional UI is simply a tool for interaction between a user and a terminal, the interactions are performed through actions such as keystrokes and pushing buttons. However, user behavior as well as activity of the five senses, i.e. hearing, sight, touch, smell, and taste, will soon be used as tools for interactions. Also, the plain graphic UN are evolving to include user-consumable content that extends beyond user-configurable interfaces such as a What You See Is What You Get (WYSIWYG) interface. This content provides the user with a view similar to the end result while the interface is being decorated and configured.

There is therefore a need to dynamically provide a rich media UI supporting free presentation and terminal-user interaction using diverse multimedia elements based on the rich media technologies. There is also a need that such a UI be provided in consideration of terminal capacity and features, and the service environment and condition of the user and the terminal.

### SUMMARY OF THE INVENTION

The present invention has been made to address at least the above problems and/or disadvantages and to provide at least the advantages described below. Accordingly, an aspect of the present invention provides an apparatus and method for providing a UI based on structured rich media data that is capable of presenting enriched data dynamically in adaptation to the user and terminal capabilities and conditions.

According to an aspect of the present invention, a method is provided for providing a structure rich media UI. Rich media content including basic configuration information, having type and identification information required for providing a UI, is created at a transmitting terminal on a communication network to which a recipient terminal has connected. The created rich media UI is encoded. The encoded rich media UI is transmitted to the recipient terminal.

According to another aspect of the present invention, a method is provided for providing a structured rich media UI. A UI format including a header and scene data is created. The header contains basic information on the UI and the scene data is composed of the UI. The UI format is encoded. The encoded UI format is transmitted. The header also includes initial information, configuration information, and layout information.

According to a further aspect of the present invention, a method is provided for processing a structured rich media UI. UI scene information is received and decoded. The scene information includes basic configuration information for providing the rich media interface, such as type and identification information of the UI and information about rich media data containing various multimedia and interactions used for providing the UI. The decoded rich media UI is provided in adaptation to service and user environments according to a judgment of a UI module.

According to an additional aspect of the present invention, an apparatus of a transmitting terminal for providing a structured rich media UI is provided. The apparatus includes a UI format generation unit that generates a UI format having UI scene information. The UI scene information includes basic configuration information having type and identification information of the UI required for providing UI, rich media data-related information having various multimedia and interactions used for providing the UI, information related to functions of the UI, and terminal and user information. The apparatus also includes an encoding unit that encodes the generated rich media UI format. The apparatus further includes a transmitting unit that transmits the encoded rich media UI.

According to another aspect of the present invention, an apparatus is provided for providing a structured rich media UI. The apparatus includes a content generator that generates a UI format including a header and scene data. The header contains basic information on the UI and the scene data is composed of the UI. The apparatus also includes an encoder that encodes the UI format generated by the content generator. The apparatus further includes a content transmitter that transmits the UI format encoded by the encoder. The header also includes initial information, configuration information, and layout information.

According to a further additional aspect of the present invention, an apparatus of a recipient terminal is provided for processing a structured rich media UI. The apparatus includes a decoding unit that decodes UI scene information. The UI scene information includes basic configuration information for providing the rich media interface such as type and identification information of the UI and information on rich media data containing various multimedia and interactions used for providing the UI. The apparatus also includes a UI module that performs operation for providing the decoded rich media UI in adaptation to service and user environments, an output unit that outputs the UI, and an input unit that processes interactions.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a flowchart illustrating operations of a terminal receiving a conventional rich media service.

FIG. 2 is a flowchart illustrating a rich media UI processing method of a recipient terminal, according to a second embodiment of the present invention;

FIG. 3 is a flowchart illustrating a rich media UI processing method of a recipient terminal, according to a third embodiment of the present invention;

FIG. 4 is a block diagram illustrating a configuration of a transmitting terminal, according to an embodiment of the present invention; and

FIG. 5 is a block diagram illustrating a configuration of a recipient terminal, according to an embodiment of the present invention.

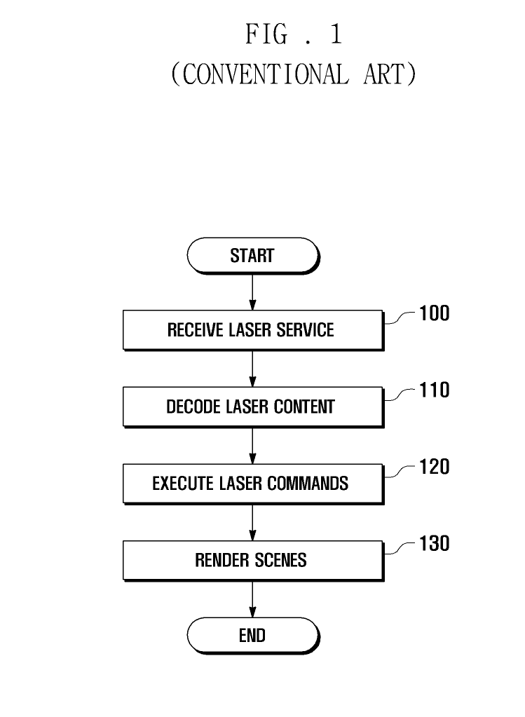

### DETAILED DESCRIPTION OF EMBODIMENTS OF THE PRESENT INVENTION

Embodiments of the present invention are described in detail with reference to the accompanying drawings. The same or similar reference numbers may be used throughout the drawings to refer to the same or similar parts. Detailed descriptions of constructions or processes known in the art may be omitted to avoid obscuring the subject matter of the present invention.

The terms and words used in the following description and claims are not limited to their dictionary meanings, but, are merely used by the inventor to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

In an embodiment of the present invention, a method is provided for providing a structured rich media data-based UI for controlling a plurality of devices connected to a network. In an embodiment of the present invention, the rich media data-based UI is structured in a hierarchical module manner, such as UI-Header>UI-Command>UI-Scene>UI-Event. An embodiment of the present invention describes how to design the structure of each module and how to represent the UIs using the modules. The presentations of the UIs are designed to abide by LASeR formats, which are currently under standardization. In an embodiment of the present invention, the operations of a terminal in association with the UI are described.

In an embodiment of the present invention, the UI information includes a presentation of local and remote data and application programs for updating and interaction, e.g. widget and Distributed Scene Component Object (DISCO).

Although the structured rich media-based UI of the following description is directed to a terminal based on a LASeR engine, such as a Rich Media Engine (RME), other types of RMEs can be adopted into the terminal. Further, although the structure rich media-based UI is described with LASeR standard terms and elements, it is obvious to those skilled in the art that the terms and elements constituting the engine, system, and data can be changed when another RME or a system other than LASeR is adopted.

In a first embodiment of the present invention, a structured rich media-based user interface format is defined first. The structured rich media-based user interface includes a Header and Scene data, and the ‘UI’ node as the highest node can include the information such as ID, Version, and vertical and horizontal lengths (i.e. aspect ratio) of the rich media-based user interface.

The Header of the structured rich media-based user interface can include the initial information, configuration information, and layout information. The initial information can include at least one of information elements including a format creation time (creationTime), last update time, version, protocol, compression status, content type, digital signature, and settings. The configuration information of the Header can include at least one of actual user interface data information including name, description, creator, file extension, rich media user interface format icon, and scene rendering technology information, access related information, license, update or correction availability, and available language. The layout information can be included in a header region of the rich media user interface format or the scene data region. The layout information can include ‘root_Layout’ and region information. The ‘root_Layout’ can include a size of the region including the entire user interface.

The scene data of the rich media user interface describes the data composing the actual user interface. The scene data can include at least one of a name space of the scene presentation technology, type information, decoder information described in the information of the header region of the rich media interface format, and layout information. The scene data of the rich media user interface can be divided into user interface scene header and a scene unit. The header information of the scene presentation data can be included in the user interface scene header unit, and the actual scene data can be included in the user interface scene unit. The media data can be included in the scene unit or in a separate media header and media unit of the respective rich media user interface. The scene unit of the user interface can be divided into a user interface command and an event unit. The user interface command and the command unit may not be designated separately. The user interface command can be set with the commands related to the action of the user interface, and the scene component data can be contained in the user interface command along with the commands of the scene component data of the user interface. The event unit can include the descriptions on the events related to the user interface and contents about the method for handling an event, when the event occurs. The event unit can be separately formed or included in the scene unit. A scene presentation unit and a media unit can be included in the scene unit or included in a separate scene unit.

In a second embodiment of the present invention, a scene presentation method of the rich media user interface format is defined and described with the LASeR as an exemplary rich media scene presentation technology.

The terminal checks the header of the structured rich media user interface format, currently being received, to acquire basic information for rendering the user and interprets the rich media data for the user interface into a scene. In order to discriminate the scene information of the user interface data and the event information, new rich media elements (such as SceneUnit, EventDescriptor, and EventHandler) can be defined. After interpreting the scene, the terminal performs a service rendering operation for rendering the data in which the terminal checks and executes the commands and processes the events.

In a third embodiment of the present invention, a method for transmitting the structured user interface format generated by a transmitter in a unified format is described.

LASeR contents can be provided by multiplexing multiple logical media streams into a single physical stream. In LASeR, Simple Aggregation Format (SAF) is used for multiplexing and synchronizing the LASeR Elementary Streams (ES). Each stream can be processed in unit of Access Unit (AU). AU is a basic unit of data to be processed at a time when the LASeR content (or stream) is serviced in multiplexed format. The structured rich media user interface format can be transmitted in the SAF stream. The recipient terminal can identify the SAF stream by checking the information of UIConfigurationUnit’. The terminal decodes the data composing the rich media user interface and provides the rich media user interface service by executing the modules required for processing the decoded data, e.g. running rich media engine, referencing structure data, and performing user interaction.

A structured rich media user interface provision method according to an embodiment of the present invention includes a procedure of creating, at a transmitting terminal on a communication network to which the recipient terminal has connected, a rich media content including basic configuration information having type and identification information required for providing user interface, a procedure of encoding the created rich media user interface, and a procedure of transmitting the encoded rich media user interface to a recipient terminal.

A structured rich media user interface processing method according to an embodiment of the present invention includes a procedure of receiving and decoding user interface scene information including basic configuration information for providing the rich media interface such as type and identification information of the user interface and information about rich media data containing various multimedia and interactions used for providing the user interface and a procedure of providing the decoded rich media user interface in adaptation to service and user environments according to a judgment of a user interface module.

An apparatus of a transmitting terminal for providing a structured rich media user interface according to an embodiment of the present invention includes a user interface format generation unit which generates a user interface format comprising user interface scene information including basic configuration information having type and identification information of the user interface required for providing user interface and rich media data-related information having various multimedia and interactions used for providing the user interface, information related to functions of the user interface, and terminal and user information; an encoding unit which encodes the generated rich media user interface format; and a transmitting unit which transmits the encoded rich media user interface.

An apparatus of a recipient terminal for processing a structured rich media user interface according to an embodiment of the present invention includes a decoding unit which decodes user interface scene information including basic configuration information for providing the rich media interface such as type and identification information of the user interface and information on rich media data containing various multimedia and interactions used for providing the user interface, a user interface module which performs operation for providing the decoded rich media user interface in adaptation to service and user environments, an output unit which output the user interface, and an input unit which processes interactions.

### First Embodiment

In the first embodiment of the present invention, a structured rich media UI provision method is described first with a basic rich media UI format. Table 2 shows a rich media UI format.

TABLE 2

<UI xmlns=“urn:2009:mpeg:uif”>
<!-- UIHeader -->
<UIHeader>
...
</UIHeader>
<!-- UIScene -->
<UIScene id=“Scene01” xmlns:lsr=“urn:2008:mpeg:LASeR”
ref_region=“pl” >
...
</UIScene>
</UI>

Referring to Table 2, a rich media UI format is composed of a header and scene data. The UI node, which is the highest node, can include an ID of the rich media UI, version information, and horizontal and vertical lengths. The UI node is structured as <UI xmlns=“urn:2009:mpeg:uif” id=“widget01” version=“1.0” height=“200” width=“200”>. The header can include additional information as shown in Table 3.

TABLE 3

<!-- UI HEADER -->
<InitialInfomation>
...
</InitialInfomation>
<UIConfigDescriprion id=“ ”>
...
</UIConfigDescriprion>
<Layout type=“UI_layout_01”>
...
</Layout>

In Table 3, the header of a rich media UI includes initial information, configuration information, and layout information. The initial information and the configuration information can be composed as a single configuration information element. The configuration information can be formed as separate data from the rich media interface format and referenced in the initial information. The initial information can include at least one of creation time (creationTime) of the rich media UI, last update time, version information, communication protocol information, compression status information, content type, digital signature, and pointer to the configuration information. The compression status information and content type information can be used for verifying the format with the data type of the rich media UI format, e.g. MIME type. For example, when the content type of the received data is unknown, the data is not processed. The digital signature of the rich media UI format and the configuration information can include a pointer to reference specific information or the configuration information itself.

Table 4 shows content of the configuration information element of Table 3. The configuration information can be provided as separate data from the rich media format.

TABLE 4
<UIConfigDescriprion id=“ ”>
<name> MPEG Rich UI </name>
<description> MPEG Rich Media UI </description>
<creator url=“ ” email=“ ” langCode=“ ”>
<name> SeoYoung </name>
<organization> Samsung </organization>
<description/>
</creator>
<extension xmlns=“urn:2008:mpeg:uif” type=“.rui”/>
<icon idref =“a.jpg” width=“ ” height=“ ” drop_shadow=“true”/>
<contents content-type=“application/LASeR” src=“ ” IDRef=“Scene01”>
<UIDecoderConfigDescriptor objectTypeIndication=“0” streamType=“0”
upstream=“false”
bufferSizeDB=“0” maxBitrate=“0” avgBitrate=“0”>
<DecoderSpecificInfo type=“xml/laser” xmlns=“urn:2008:mpeg:LASeR”>
<param name=“ ” value=“ ”/>
</DecoderSpecificInfo>
<profileLevelIndicationIndexDescr> -
</profileLevelIndicationIndexDescr>
</UIDecoderConfigDescriptor>
</contents>
<access local=“true” network=“true” plugin=“true” system=“true”>
<accessSpecificInfo protocol“ ”host=“ ” port=“ ” path=“ ”/>
</access>
<license> - </license>
<allowModification allow=“false”/>
<language>
<lang id=“ ” title=“ ” code=“ ” font-type=“ ” font_src=“ ”
default=“true”/>
</language>
<privateData> manifest format, manifest extension, UI Markup(Mime),
host
runtime, security
model </privateData>
</UIConfigDescriprion>

As shown in Table 4, the configuration information of the rich media UI format can include at least one of the actual UI data information, access information, license, update or modification availability, and available language. The UI data information includes name, description, creator, file extension, rich media UI format icon, and scene presentation technology used for rendering scenes.

Among the information elements that can be included as the configuration information, file extension information can include a name space of the rich media UI format and a file extension name. Among the information elements that can be included as the configuration information, icon information can include information on an image or animation, content type of the data to be used as the icon, horizontal and vertical length, and visual effect to be used along with, e.g., ‘drop shadow’. The content information of the configuration information can contain information on data of the actual UI and further include content type of scene presentation technology used as the scene rendering information of the rich media UI and reference information. The content information can further include decoder information for the scene presentation technology. The rich media UI format can be designed such that the content information is included in a UI scene data region rather than in the configuration information. According to the design structure of the scene data region, the content information can be included in a header of the scene data region or another section. The access information relates to the restriction conditions for access to exchange data, and includes local or network data exchange availability, plug-in usability, and system accessibility. The access information can further include information such as protocol available for data exchange, host address, port number, and path. The available language information can include information about languages that can be used in the rich media UI format. For example, the available language information can include language code, font-related information, and whether the language is a default. The configuration information can further include information about whether the rich media UI is a single UI, downloaded, or installed.

Table 5 shows content of the layout information element of Table 3. The layout information can be included in the header region of the rich media UI format or in the scene data region.

TABLE 5
<Layout type=“UI_layout_01”>
<root_Layout width=“ ” height=“ ” bgColor=“red”
transparency=“100%”/>
<region id=“p1” title=“circle” geometry_type=“ ” left=“10” top=“10”
width=“110”height=“130”
fit=“center|fill|meet|scroll|slice” z-index=“ ”/>
</Layout>

As shown in Table 5, the layout information includes ‘root_Layout’ information and region information. The ‘root_Layout’ can indicate a size of an entire UI. The region information can be configured such that each UI references corresponding region information, or such that each part of the UI references corresponding region information. Also, each region can reference the UI content. The region information can include the shape, size, and position of the region, and the shape of the UI formed at the corresponding region, e.g., positioning at a center, filling out the entire region, activating a scroll bar, and maintaining scale even when the UI is larger than the region. Also, an order of layers of the corresponding region can be indicated. For example, the UI at a region having a ‘z-index’ attribute value indicating a lowest layer in an order of layers is presented on top of a display.

Table 6 shows content of the scene data of a rich media UI.UI

TABLE 6

<!-- UIScene -->
<UIScene id=“Scene01” xmlns:lsr=“urn:2008:mpeg:LASeR”
ref_region=“pl” >
<UISceneHeader> ... </UISceneHeader>
<UIMediaHeader> ... </MediaHeader>
<UIMediaUnit/>
<UISceneUnit>
<UICommand> ...</UICommand>
<EventUnit>
<EventDescription IDRef=“ ”>
</EventDescription>
<EventHandler> ... </EventHandler>
</EventUnit>
</UISceneUnit>
</UIScene>

As shown in Table 6, the scene data of the rich media UI can include at least one of name space of the scene presentation technology, type information, decoder information and layout information described in the information of the header region of the rich media UI format.

The scene data of the rich media UI can be divided into a UI scene header and a scene unit. The header information of the scene presentation data is included in the UI scene header, and the actual scene data can be included in the UI scene unit. The media data can be included in the scene unit or in a separate media header and media unit of each rich media UI. The scene unit of the UI can be divided into a UI command and an event unit. The UI command and the event unit may not be designated separately. The UI command can be set with the commands related to the operations of the UI and includes scene component data containing the commands of the scene component data of the UI. The event unit can contain a description about events related to the UI and methods for processing the events. The event unit can be formed separately as in Table 6 or included in the scene unit.

The scene presentation unit and the media unit are included in the scene unit as shown in the example of Table 6 or can be included in respective separate scene units.

One of LASeR, BIFS, and SVG can be used as the scene presentation technology for the UI. The basic information about the scene presentation technology can be acquired from the content information of the configuration information.

Table 7 shows information about the functions related to the UI.

TABLE 7

<UIFunctionDescriptor>
<FunctionList id=“photo_album_function”>
<Function id=“01” name=“move”>
<action ref=“action( );”/>
</Function>
</FunctionList>
</UIFunctionDescriptor>

As shown in Table 7, the function information can include the name of each function and information about an actual operation referenced by the corresponding function. For example, if a scene of the rich media UI, having scene number #1, contains information about data copy or an event, the function information can reference the function information describing the data copy function. The function information can include the reference information about the scene composition information that can be referenced. The function information also can be designed to be linked to or referenced by the UI.

Table 8 shows user, terminal, network, and service information related to the UI.

TABLE 8

<UIProfile id=“Profile01”>
<UserProfile/>
<UIDeviceProfile id=“ ” ref_UIpresenation=“UI_w3300”>
<BasicInformation>
<manufacture/>
<ModelName/>
<SerialNumber/>
</BasicInformation>
<UIDeviceCapability>
<DisplaySize/>
<Sound/>
<additional>
<camera/>
<external_memory/>
</additional>
</UIDeviceCapability>
<UIDeviceInputType/>
<Service_List id=“UI_w3300_ServiceList”>
<Service/>
<Service/>
</Service_List>
</UIDeviceProfile>
<NetworkProfile/>
<ServiceProfile/>
</UIProfile>

As shown in Table 8, terminal information can include basic information (such as, manufacture information, model name of the terminal, and serial number), capability information (such as, display size, sound, memory, camera), information on the input device for user interaction, and information on service lists provided by the terminal. These information items can be used in association with a scene unit specific to the terminal.

The information about the terminal, user, network, and service is reference information of the rich media UI and can include a specification and capability of the terminal, a level of the UI, and service list information.

The rich media UI format of the first embodiment of the present invention can include the units described above or only reference information that references the unit information.

### Second Embodiment

In the second embodiment of the present invention, a scene presentation method of a rich media UI format is described in which LASeR is the rich media scene presentation technology.

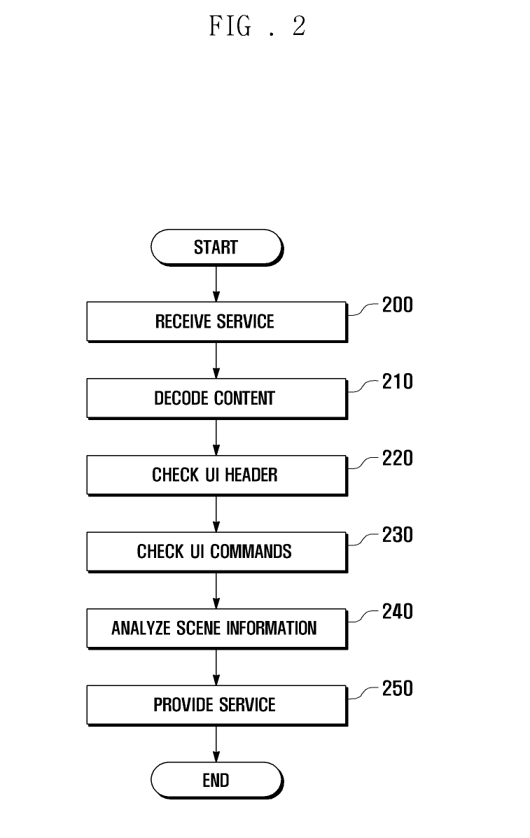

FIG. 2 is a flowchart illustrating a rich media UI processing method of a recipient terminal, according to the second embodiment of the present invention.

Referring to FIG. 2, the recipient terminal receives service content in step 200 and decodes the received service content in step 210. After decoding the service content, the recipient terminal checks the header of the decoded UI information in step 220 to acquire basic information for rendering the UI. The recipient terminal then checks UI commands in step 230. Checking the UI commands can be skipped according to the format of the data. The recipient terminal checks the rich media data of the UI and provides the rich media data to a rich media engine. The rich media engine analyzes the rich media data in step 240. New elements (such as, SceneUnit, EventDescriptor, and EventHandler) can be defined as rich media components for discriminating the scene information and the event information of the UI data. After acquiring the scene information and event information in the analysis result, the recipient terminal performs a service rendering in step 250 to provide the user with the rich media service by checking and executing the commands and events contained in the scene and event information.

Table 9 shows LASeR content received and processed in the recipient terminal as described with reference to FIG. 2.

TABLE 9
<UIHeader xmlns:ui=“mpeg:2008:MPEG” version=“1.0” height=“100”
width=“100”
config=“ui_config.xml”/>
<ui:Command>
<LASeRHeader ... />
<NewScene>
<svg>
<ui:sceneUnit>
<image id=“photo01” ... xlink:href=“a/aa/aaa/01.jpg”/>
<image id=“photo02” ... xlink:href=“a/aa/aaa/02.jpg”/>
<image id=“photo03” ... xlink:href=“a/aa/aaa/03.jpg”/>
</ui:SceneUnit>
<ui:EventUnit>
<ui:EventDescription xlink:href=“ ”>
<ev:listener id=“SelectItem” event=“activate”
handler=“#selectItemScript”/>
</ui:EventDescription>
<ui:EventHandler>
<script id=“SelectItemScript”> ... </script> </ui:EventHandler>
</ui:EventUnit>
</svg>
</NewScene>
</ui:Command>

### Third Embodiment

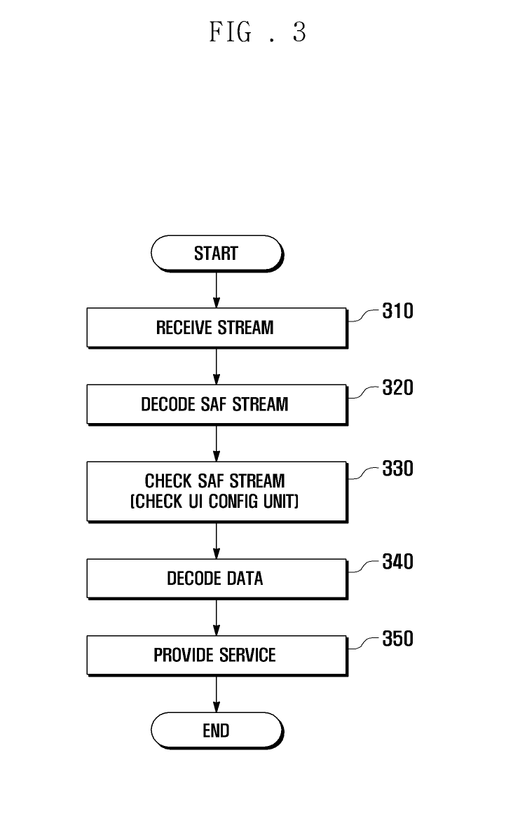

LASeR content can be serviced in the form of multiple logical media streams multiplexed into a physical stream. Simple Aggregation Format (SAF) is a format that multiplexes and synchronizes the LASeR Elementary Streams (ESs). Each stream can be processed in an Access Unit (AU). AU is a basic unit of data to be processed at a time when the LASeR content (or stream) is serviced in multiplexed format. The structured rich media UI format created at the transmitting terminal can be transmitted in the form of an SAF stream. The recipient terminal processes the SAF stream as shown in FIG. 3.

FIG. 3 is a flowchart illustrating a rich media UI processing method of a recipient terminal, according to the third embodiment of the present invention.

Referring to FIG. 3, the recipient terminal receives service data stream in step 310 and decodes the received service data stream into an SAF stream in step 320. The recipient terminal identifies the decoded SAF stream in step 330. The SAF stream identification can be performed by checking the ‘UIConfigurationUnit’ defined in the third embodiment of the present invention. After identifying the SAF stream based on ‘UIConfigurationUnit’, the recipient terminal decodes the data composing the UI in step 340. Finally, the recipient terminal provides the user with the rich media UI service in step 350 by rendering the decoded data using corresponding modules, i.e., executing the rich media engine, referencing structure data, and executing user interactions.

Table 10 shows content of ‘UIConfigurationUnit’ as a new type of integrated format access unit for delivering information on the integrated rich media UI data. The transmitting terminal inserts the ‘UIConfigurationUnit’ for indicating that the corresponding stream carries the rich media UI. By checking the ‘UIConfigurationUnit’, the recipient terminal can recognize that the rich media UI data is received. The recipient terminal receiving the ‘UIConfigurationUnit’ performs operations such that the payload, having a data type of ‘0x04’, following the receipt of the ‘UIConfigurationUnit’, is transmitted to the UI analyzer.

TABLE 10

Class UIConfigurationUnit {
bit(8) objectTypeIndication
bit(8) streamType;
if(streamType == 0xFF && objectTypeIndication == 0xFF) {
bit(16) mimeTypeLength;
byte mimeType[mimeTypeLength];
}
bit(16) version;
bit(1) updateData;
bit(1) permanent;
bit(16) urlLengh
byte url[urlLength];
SimpleDecoderSpecificInfo decSpecificInfo[0 ...1];

Referring to Table 10, the recipient terminal identifies the data type by referencing ‘objectTypeIndication’ and ‘streamType’ of the ‘UIConfigurationUnit’, checks the content type by referencing ‘mimeType’, and determines whether the received data can be processed in the recipient terminal. The recipient terminal checks the version of the ‘UIConfigurationUnit’ by referencing the ‘version’ information. ‘updateData’ is a flag to indicate whether the data following the ‘UIConfigurationUnit’ is for an update. ‘permanent’ indicates how to handle the data following the ‘UIConfigurationUnit’. If ‘permanent’ is set to true, the UI data is to be stored in the terminal. ‘url’ is referenced to acquire the UI information to be used as a simplified UI or an icon. ‘SimpleDecoderSpecificInfo’ can include information that can be contained in the header unit of the UI data. Table 11 shows a modified ‘UIConfigurationUnit’ of the ‘UIConfigurationUnit’ of Table 10.

TABLE 11

Class UIConfigurationUnit {
if(streamType == 0xFF && objectTypeIndication == 0xFF) {
bit(16) mimeTypeLength;
byte mimeType[mimeTypeLength];
}
bit(16) version;
bit(1) updateData;
bit(1) permanent;
bit(16) urlLengh
byte url[urlLength];

In Table 11, the recipient terminal acquires the aforementioned information from the ‘UIConfigurationUnit’ and the actual UI header information from a header type access unit of the integrated format. The recipient terminal can identify the UI header information by referencing ‘ObjectTypeIndicator’ or the fields related to ‘mimeType’.

As described above, in an embodiment of the present invention, a method is provided for providing a UI based on the rich media data that can control a plurality of terminals connected to a network. In an embodiment of the present invention, the rich media data-based UI is structured in a hierarchical module manner as UI-Header>UI-Command>UI-Scene>UI-Event. An embodiment of the present invention describes how to design the structure of each module and how to represent the UIs using the modules. The presentation of the UIs are designed to abide by LASeR formats currently undergoing standardization.

The hierarchically structured UI can be transmitted in the form of a file or can be streamed, and multiple UI files can be combined and divided for processing. Multiple images may be visible on a single screen, and different codec operations are provided for presenting the UI. In an embodiment of the present invention, the hierarchical structure of the UI can be provided in the form of m×n layers to a terminal for controlling a plurality of devices connected to a network.

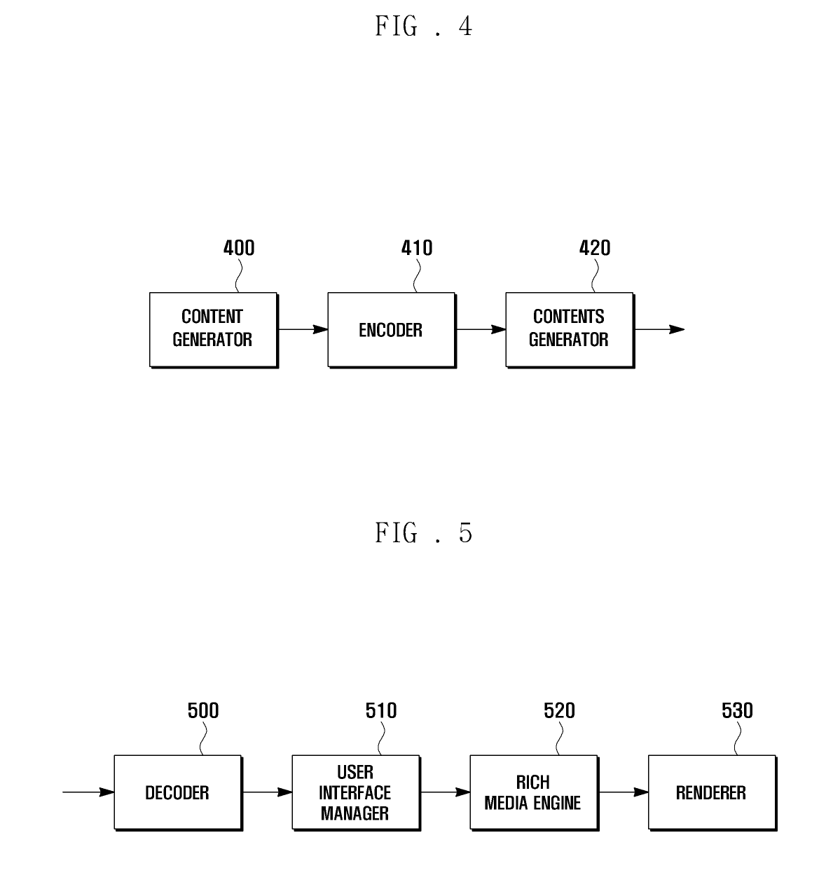

FIG. 4 is a block diagram illustrating a configuration of transmitting terminal according to an embodiment of the present invention.

Referring to FIG. 4, the transmitting terminal includes a content generator 400, an encoder 410, and a content transmitter 420.

The content generator 400 generates a UI format containing basic configuration information including the type and identity information of the UI, UI scene information including rich media data information such as diverse multimedia and interactions, information related to the functions of the UI, and terminal and user information related to the UI. The content generator 400 outputs the UI format to the encoder 410.

The encoder 410 encodes the UI format input by the content generator 400 and outputs the encoded UI format to the content transmitter 420.

The content transmitter 420 transmits the encoded UI format input by the encoder 410. In an embodiment of the present invention, the UI format can be transmitted using an SAF. The content transmitter 420 can insert a ‘UIConfigurationUnit’ into the SAF stream. The ‘UIConfigurationUnit’ can include at least one of ‘mimeType’, ‘version’, ‘updateData’, ‘permanent’, and ‘SimpleDecoderSpecificInfo’.

FIG. 5 is a block diagram illustrating a configuration of a recipient terminal according to an embodiment of the present invention.

Referring to FIG. 5, the recipient terminal includes a decoder 500, a UI manager 510, a rich media engine 520, and a renderer 530.

The UI format received at the recipient terminal is input to the decoder 500. The decoder 500 decodes the UI format and outputs the decoded UI data to the UI manager 510. The UI manager 510 analyzes the UI data input by the decoder 500 to check the basic configuration information including the type and identity information of the UI, UI scene information including rich media data information such as diverse multimedia and interactions, information related to the functions of the UI, and terminal and user information related to the UI. The UI manager 510 first extracts the basic information required for rendering the UI from the configuration information and outputs the basic information to the rich media engine 520 according to the UI scene presentation technology. The rich media engine 520 extracts the scene component information and outputs the scene component information to the render 530. The render 530 renders the UI using the scene component information and, as a consequence, the UI is output. When no scene component information of the UI is included in the UI format, the renderer 530 interprets the scene information or function information referenced by the UI format and acquires the scene component information of the UI indicated by the scene or function information from a remote or a local storage.

As described above, the apparatus and method for providing a UI based on structured rich media data supports free presentation and interaction with a user using diverse multimedia elements in adaptation to the capability and features of the terminal and service environment and condition of the terminal and user. Also, the apparatus and method for providing a UI based on structured rich media data is capable of transmitting and adapting a structured rich media UI to various types of terminals and users, thereby providing a flexible and dynamic UI through real time transmission and update.

While the present invention has been shown and described with reference to certain embodiments thereof, it will be understood by those skilled in the art that various changes in form and detail may be made therein without departing from the spirit and scope of the present invention, as defined in the appended claims.

What is claimed is:

1. A method for providing a structured rich media User Interface (UI) for a transmitting terminal of a communication system, comprising the steps of:
creating a UI format comprising a header and scene data, wherein the header includes basic information on the UI and the scene data includes the UI;
encoding the UI format; and
transmitting the encoded UI format,
wherein the header further comprises initial information, configuration information, and layout information.

2. The method of claim 1, wherein the initial information comprises at least one of a creation time, a last update time, version information, communication protocol information, a compression status, a content type, digital signature information, and information for checking the configuration information.

3. The method of claim 1, wherein the configuration information comprises at least one of actual UI data information, access information, a license, a used language, and update and modification availability, and wherein the actual UI data information comprises a name, a description, a creator, a file extension, a rich media UI format icon, and information on a scene presentation technology to be used for rendering scenes.

4. The method of claim 1, wherein the layout information comprises at least one of a size (root_Layout) of a region including the UI and information on a shape of the UI in the region.

5. The method of claim 1, wherein creating the UI format comprises generating the scene data including at least one of a name space of scene presentation technology, a type information, a decoder information described in information of the header of the UI format, and the layout information.

6. The method of claim 1, wherein creating the UI format comprises generating indication information for indicating a stream of the UI, and wherein transmitting the encoded UI format comprises streaming the UI format in an integrated format.

7. The method of claim 6, wherein the indication information comprises at least one of ‘objectTypeIndication’, ‘streamType’, ‘mimeType’, ‘version’, ‘updateData’, ‘permanent’, and ‘SimpleDecoderSpecificInfo’.

8. An apparatus for providing a structured rich media User Interface (UI) comprising:
a content generator which generates a UI format comprising a header and scene data, wherein the header includes basic information on the UI and the scene data includes the UI;
an encoder that encodes the UI format generated by the content generator; and
a content transmitter that transmits the UI format encoded by the encoder,
wherein the header further comprises initial information, configuration information, and layout information.

9. The apparatus of claim 8, wherein the initial information comprises at least one of a creation time, a last update time, version information, communication protocol information, a compression status, a content type, digital signature information, and information for checking the configuration information.

10. The apparatus of claim 8, wherein the configuration information comprises at least one of actual UI data information, access information, a license, a used language, and update and modification availability, and wherein the actual UI information comprises a name, a description, a creator, a file extension, a rich media UI format icon, and information on a scene presentation technology to be used for rendering scenes.

11. The apparatus of claim 8, wherein the layout information comprises at least one of a size (root_Layout) of a region including the UI and information on a shape of the UI in the region.

12. The apparatus of claim 8, wherein the scene data comprises at least one of a name space of scene presentation technology, a type information, a decoder information described in information of the header of the UI format, and the layout information.

13. The apparatus of claim 8, wherein the content generator generates indication information for indicating a stream of the UI, and the content transmitter transmits the encoded UI format in an integrated format.

14. The apparatus of claim 13, wherein the indication information comprises at least one of ‘objectTypeIndication’, ‘streamType’, ‘mimeType’, ‘version’, ‘updateData’, ‘permanent’, and ‘SimpleDecoderSpecificInfo’.
